(19) United States
(12) Patent Application Publication
(10) Pub. No.: US 2015/0110921 A1
(43) Pub. Date: Apr. 23, 2015

(54) USE OF A DRIED STARCH BASED FLOUR

(71) Applicant: Lyckeby Culinar AB, Fjälkinge (SE)

(72) Inventor: Jan-Olof Lundberg, Malmo (SE)

(73) Assignee: Lyckeby Culinar AB, Fjälkinge (SE)

(21) Appl. No.: 14/402,634

(22) PCT Filed: May 21, 2013
(86) PCT No.: PCT/SE2013/050575

§ 371 Date: Nov. 20, 2014

(30) Foreign Application Priority Data
May 23, 2012 (SE) 1250521-0

(51) Int. Cl. A21D 2/08

(52) U.S. Cl. CPC A21D 2/08
USPC 426/48; 426/549

(57) ABSTRACT

The present invention describes use of a dried starch based flour for mixing with a water containing start product, which mixing enables production of an application product, wherein the water containing start product has the form of a liquid, paste or a powder with volatile water and wherein the dried starch based flour is dried to a level below its moisture equilibrium, and wherein the production of an application product, where at least a part of the water is transferred from the start product to the dried starch based flour, results in a transformation of the start product from the form of a liquid, paste or a powder with volatile water into an application product in the form of a powder.

### FIELD OF THE INVENTION

The present invention relates to use of a dried starch based flour, particularly in relation to food applications.

### TECHNICAL BACKGROUND

Starch is a component comprised in various raw materials, such as potato, rice, maize, tapioca, etc. Further, starch is an often used component in various food applications, such as in coating technology or other encapsulation techniques. In e.g. WO07123466 a flavour release material is described, comprising a vegetable fibrous material with natural och artificial cavities. The flavour release material contains a solution containing at least one lipophilic flavouring and a lipophilic component, which solution is applied in the cavities to achieve controlled release of flavourings. The fiber material may be potato based and have a starch content of up to 16% by weight.

Further, starch based flours are previously known, e.g. as a component for use for mixing in foodstuff. One clear example is in bread, since e.g. ordinary wheat flour contains about 70% starch.

One aim of the present invention is to provide use of a dried starch based flour, especially in relation to food applications.

### SUMMARY OF THE INVENTION

The purpose given above is achieved by the present invention providing use of a dried starch based flour for mixing with a water containing start product, which mixing allows production of an application product, wherein the water containing start product has the form of a liquid, a paste or a powder with volatile water and wherein the dried starch based flour is dried to a level below its moisture equilibrium, and wherein the production of an application product, where at least a part of the water passes from the start product to the dried starch based flour, results in a conversion of the start product from the form of a liquid, paste or a powder with volatile water to an application product in the form of a powder. The process according to the present invention is primarily controlled by the level of water activity and secondary by the actual water content. A main purpose of the present invention is accordingly conversion from liquid form or the form of a paste of a water-based (start) product to powder, and as such the present invention is an alternative to spray drying. The completion means that water is transferred from the start product to the dried starch based flour. At the same time the water activity of the end product (application product) is controlled.

With the expression “water containing start product” is meant a material containing water. The start product may be a liquid, a paste or may e.g. comprise living cells, and it does not have to be a material in the form of a liquid. It may further have the form of a “powder with volatile water” and an example is tomato powder. Regardless, a completely dry material is not contemplated.

According to one specific embodiment of the present invention the water containing start product is in the form of a liquid or a paste.

With the expression “starch based flour” is meant all flours that are possible to obtain from potato, rice, tapioca, maize, but also other types of cereals, such as cereals, grains, etc. It is important to realize that the starch based flour according to the present invention does not only comprise starch, but also other components. Although the flour is dried it does of course contain a certain amount of water. Other examples of components that are comprised are fibers, such as potato fibers, fats and proteins. The limiting factor for the starch based flour according to the present invention is thus not the type of component as such, but the fact that starch is present in the flour and that the dryness in the flour is below its moisture equilibrium. That the level is below the moisture equilibrium results in the flour having the power of attracting water. The moisture equilibrium for different types of flour varies according to the present invention. As an example one can mention potato flour, where the moisture equilibrium is 20%, and cereal flour, i.e. flour based on cereals, having a moisture equilibrium of 15%. Regardless what type is used according to the present invention the flour will be dried to a level that is below these moisture equilibriums.

### SPECIFIC EMBODIMENTS OF THE INVENTION

As is indicated above, the present invention leads to that it is possible to control the water activity in the application product. According to a specific embodiment of the present invention control of the water activity of the application product is made possible.

The water activity or a_{w} is a well established measure or index for the possibility of microbial growth and is considered better than water content. The water activity depends on the temperature and normally a_{w} increases with increased temperature, except in products with crystalline salt or sugar. Substances with higher a_{w} tend to support more microorganisms. Bacteria normally require at least 0.91, yeast almost 0.8, and fungi at least 0.7. At a_{w} values below 0.6, microorganisms such as mold, are not able to grow. Enzymes may, however, show activity below these values. According to the present invention this means that it is not necessarily obvious that it ends in itself to suppress a_{w} as much as possible, but instead to hold an optimal value where no “dangerous” microorganisms can grow, while certain wanted have the possibility to be preserved or enzymes maybe can keep their activity.

For foodstuff water activity is also an important value in terms of extending or at least securing a long shelf-life. Further, a low water activity may also see to that moisture migration is limited within a foodstuff. As an example, if a foodstuff with high water activity is mixed with one with lower, as may be the case with certain dried fruit in muesli, water may migrate from the fruit to the muesli over time.

The relationship between water activity and shelf-life has further been addressed in the description of different techniques within food technology. WO09061222 describes a so called storage durable composition containing a biological material, an oil and a biopolymer having a water activity lower than 0.7. The technology that is described concerns stabilization of the biological material by coating thereof with oil, which then is coated with the biopolymer. The composition may further comprise dehydrated substances from e.g. rice powder, corn starch powder, potato starch powder, lactose, sacharose, glucose, mannitol, sorbitol, calcium carbonate, silica, calcium phosphate, cellulose, polyethyleneglycol, or combinations thereof. Further, a composition may be comprised in a foodstuff, e.g. in a dried foodstuff, e.g. muesli can be contemplated.

As has been mentioned above, starch powders are previously known. Further, it is known that powders as such may have a desiccative effect if combined with materials comprising fluid. The present invention, however, describes control and/or suppression of bacterial growth by regulation of the water activity in an application product by use of a dried starch based flour, which is not contemplated or accomplished according to WO09061222. Dried starch based flour is used according to WO09061222 only as a desiccant, which also is previously known.

According to a specific embodiment of the present invention the use according to the invention is considered to include control and/or suppression of baterial growth in the start product containing water.

With the expression “control and/or suppression of bacterial growth” is meant both the possibility to favour certain growth and also total elimination of other growth. The present invention is especially aimed at suppression or elimination of the possibility for certain microorganisms to establish and grow. The present invention also comprises the aim to bind water in a given raw material to avoid migration of water to other raw materials that are sensitive to water levels in another way than the dried starch based flour according to the present invention. An example of this is yeast extract which is a very hygroscopic powder.

It can further be mentioned that there, however, are certain bacteria for which it may be of interest to keep an environment where these can grow. One example of such a type is lactic-acid bacteria.

As is mentioned above, the present invention is aimed at the use of dried starch based flour for regulation of the water activity in a product and thereby control or suppression of the bacterial growth in the product. This further means that the dried flour has a lower water content than its normal moisture equilibrium. This is the driving force for accomplishing desired effect according to the present invention. According to one embodiment of the present invention the dried starch based flour has a water content of lower than 10% by weight. According to one specific embodiment the dried starch based flour has a water content within a range of 4-10% by weight. For the function the water content may be as low as you like, but since it is costly to force the drying of the flour very far it is more optimal to lie on a level in the range of 5-7% by weight. Further, there is also an increased risk of dust explosions if the flour is too dry. Typical for today are flours dried to a moisture level of about 6% by weight. According to one specific embodiment of the present invention a potato flour with a water content in the range of 4-10% by weight, such as between 5 and 7% by weight, e.g. about 6% by weight, is contemplated.

The base of the present invention lies in the fact that when the dried flour comes in contact with a humid material forces arise in the flour to revert to or approach the original moisture equilibrium of the material. The flour thereby has a strong absorbing effect on water. With water activity the equilibrium position versus the relative atmospheric humidity is measured. At a water activity of 0.75 the moisture content in potato starch is 20% and in cereal starch 15%, where the difference lies in different crystal structures in the material.

As is described above, dried potato flour is a very useful alternative according to the present invention. Ordinary potato flour has a moisture equilibrium of 20%, at which level the flour is microbiologically stable. A dried potato flour that is used according to the present invention may theoretically bind water from a start material, such as a liquid or a paste, up to the level where the flour retrieves its moisture equilibrium, and nevertheless cover a microbiologically stable product. This means that a product that is not able to bind water physically and microbiologically stable, but is present as a liquid or a paste, may with the help of dried potato flour according to the present invention be transformed to a free-flowing microbiologically stable powder. At a water content of 6% for dried potato flour you can theoretically bind up to 140 gram water per kg potato flour, which then is transferred from the liquid or paste.

If a flour is dried the water activity and moisture content are lowered in the material. If this dried flour is brought into contact with a damp environment, e.g. a wet material, the flour will attract moist until the moisture equilibrium is reached again, if this is possible. This further results in that it is important to keep a dried flour in a dry environment, such as in completely moisture-proof packages, so that the flour does not attract moist before intended use.

According to the present invention the use of a dried starch based flour, bringing it in contact with material and thereby creating an application product with, relatively seen, controlled water activity, also results in that it is possible to transform liquid products into microbiologically stable powder products. This is of course of great interest within various different applications, but for several foodstuffs it is of great importance. According to one embodiment of the present invention the water containing start product therefore is a foodproduct or a food additive. This further means that foodstuffs are produced according to the present invention, i.e. the application product is also a foodstuff or a food additive.

As an example of a food additive starter cultures or probiotic preparations may be mentioned. These starter cultures may contain lactic acid bacterium which then are intended to be combined with other foodstuff, such as soured milk, yoghurt and the like. The use of probiotics in these types of foodstuff occurs today.

These types of starter cultures or probiotic mixtures are possible to stabilize according to the present invention. According to a specific embodiment of the present invention the water containing start product therefore is a food additive in the form of a starter culture, which also may be freeze-dried. By the combination of these starter cultures which per se have relatively high water activities, e.g. also when they are freeze-dried, which means that they must be stored at minus 18 degrees, with a dried starch based flour according to the present invention they get considerably more microbiologically stable and may therefore be stored more simple and cheaper than normally done today. Today, such storage is done at very low freeze temperatures, even when they are freeze-dried. This will not be necessary if they are combined with a dried starch based flour according to the present invention. By controlling the water activity it is also possible to regulate the activity of starter cultures/probiotics and enzyme products during storage in products with a low water content, e.g. breakfast cereals, such as corn flakes, bran flakes or muesli. According to the present invention is it thus possible, with the help from admixture of dried potato flour, to control the water activity in such a way that starter cultures are put into rest at room temperature.

It may further be mentioned that enzyme mixtures may be possible food additives. According to a specific embodiment of the present invention the water containing start product therefore contains enzymes and whereby control and/or suppression of bacterial growth in the water containing start product also comprises control and/or suppression och enzyme activity, i.e. control and/or suppression of the enzymatic process.

### EXAMPLE

In one example according to the present invention a transformation of goat cheese from paste to powder was conducted. 25% of the cheese paste with 47% dry substance was mixed with 75% dried potato flour in a high-speed mixer. The result was a more or less free-flowing powder. The water activity was 0.70 at 23.1° C. and the product was microbiologically stable. This was tested also by measurement of the water activity after one more day, where the water activity was at the same level.

1. A method of producing an application product, the method comprising:
mixing a dried starch based flour with a water containing start product wherein the water containing start product has the form of a liquid, paste or a powder with volatile water; and wherein the dried starch based flour has a water content below its moisture equilibrium such that control and/or suppression of the bacterial growth in the water containing start product is made possible;
wherein the mixing transfers at least a part of the water from the water containing start product to the dried starch based flour, resulting in transformation of the start product into the application product in the form of a powder;
and wherein regulation of the water activity is made possible in the application product.

2. The method according to claim 1, wherein the water containing start product has the form of a liquid or paste.

3. The method according to claim 1, wherein the dried starch based flour has a water content lower than 10% by weight.

4. The method according to claim 1, wherein the dried starch based flour has a water content in the range of 4-10% by weight.

5. The method according to claim 1, wherein the dried starch based flour has a water content in the range of 5-7% by weight.

6. The method according to claim 1, wherein the dried starch based flour is a potato flour.

7. The method according to claim 1, wherein the water containing start product is a food product or a food additive.

8. The method according to claim 7, wherein the water containing start product is a food additive in the form of a starter culture or probiotics.

9. The method according to claim 1, wherein the water containing start product contains enzymes and wherein control and/or suppression of bacterial growth in the water containing start product also includes control and/or suppression of enzyme activity.
